(19) United States
(12) Patent Application Publication
(10) Pub. No.: US 2014/0183782 A1
(43) Pub. Date: Jul. 3, 2014

(54) MOLD ASSEMBLY FOR FORMING A CAST COMPONENT AND METHOD OF MANUFACTURING A MOLD ASSEMBLY

(71) Applicant: GENERAL ELECTRIC COMPANY, Schenectady, NY (US)

(72) Inventor: Sandra Beverly Kolvick, Simpsonville, SC (US)

(73) Assignee: GENERAL ELECTRIC COMPANY, Schenectady, NY (US)

(21) Appl. No.: 13/733,480

(22) Filed: Jan. 3, 2013

(51) Int. Cl. B22C 9/22; B29C 45/26; B29C 45/00; B22C 9/00; B22D 25/00

(52) U.S. Cl. CPC B22C 9/22; B22C 9/00; B22D 25/00; B29C 45/00; B29C 45/26
USPC 264/219; 164/271; 164/6; 249/117

(57) ABSTRACT

A mold assembly for forming a cast component includes a primary mold structure having a predetermined geometry portion for shaping a primary region of the cast component. Also included is at least one additional mold structure integrated with the primary mold structure, the at least one additional mold structure comprising a geometry for defining at least one feature in the cast component.

### BACKGROUND OF THE INVENTION

The subject matter disclosed herein relates to a mold assembly and to a method of forming a cast component.

Mold assemblies are employed in casting processes to form metal components in a wide-range of industries. Examples of industries benefitting from a casting process include aerospace and power industries, which require intricate features on various components. Typically, a single mold is required to form components, but such a mold is often costly as increasingly intricate features are machined therein. In some cases, a rather generic mold is employed to form similar components, which are then machined to form a final component with the desired intricate features. Therefore, investing in a large number of castings with the desired intricate features or machining a generic component leads to time and cost inefficiencies. Additionally, component design requirements often change over time and such changes require modifications to the mold or a change in the machining process to produce the final component, again leading to undesirable time and cost impacts.

### BRIEF DESCRIPTION OF THE INVENTION

According to one aspect of the invention, a mold assembly for forming a cast component includes a primary mold structure having a predetermined geometry portion for shaping a primary region of the cast component. Also included is at least one additional mold structure integrated with the primary mold structure, the at least one additional mold structure comprising a geometry for defining at least one feature in the cast component.

According to another aspect of the invention, a method of manufacturing a mold assembly is provided. The method includes forming a primary mold structure having a predetermined geometry portion for shaping a primary region of the cast component. Also included is forming at least one additional mold structure having a geometry for defining at least one feature in the cast component. Further included is integrating the at least one additional mold structure to the primary mold structure to form the mold assembly.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a turbine system;

FIG. 2 is a schematic illustration of a mold assembly having a primary mold structure and at least one additional mold structure;

FIG. 3 is a schematic illustration of a cast component material disposed in the mold assembly;

FIG. 4 is a schematic illustration of a cast component formed by the mold assembly;

FIG. 5 is a schematic illustration of the cast component having a first segment and a second segment joined; and

FIG. 6 is a flow diagram illustrating a method of forming the mold assembly.

The detailed description explains embodiments of the invention, together with advantages and features, by way of example with reference to the drawings.

### DETAILED DESCRIPTION OF THE INVENTION

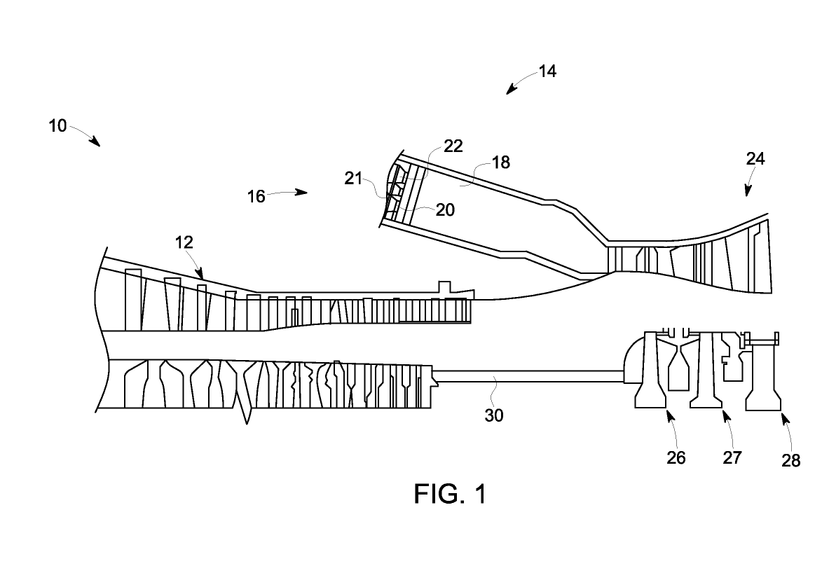

Referring to FIG. 1, a gas turbine engine 10 constructed in accordance with an exemplary embodiment of the present invention is schematically illustrated. The gas turbine engine 10 includes a compressor 12 and a plurality of combustor assemblies arranged in a can annular array, one of which is indicated at 14, each combustor assembly 14 including a combustor chamber 18, as well as a plurality of nozzles 20-22. The fuel and compressed air are passed into the combustor chamber 18 and ignited to form a high temperature, high pressure combustion product or air stream that is used to drive a turbine 24. The turbine 24 includes a plurality of stages 26-28 that are operationally connected to the compressor 12 through a compressor/turbine shaft 30 (also referred to as a rotor).

In operation, air flows into the compressor 12 and is compressed into a high pressure gas. The high pressure gas is supplied to the combustor assembly 14 and mixed with fuel, for example natural gas, fuel oil, process gas and/or synthetic gas (syngas), in the combustor chamber 18. The fuel/air or combustible mixture ignites to form a high pressure, high temperature combustion gas stream. In any event, the combustor assembly 14 channels the combustion gas stream to the turbine 24 which converts thermal energy to mechanical, rotational energy.

A turbine system, such as the gas turbine engine 10 described above, includes a number of turbine components that are manufactured for use in conjunction with the turbine system. It is to be appreciated that the embodiments described below may be used in conjunction with components for other turbine systems, such as a steam turbine, for example, or other applications altogether.

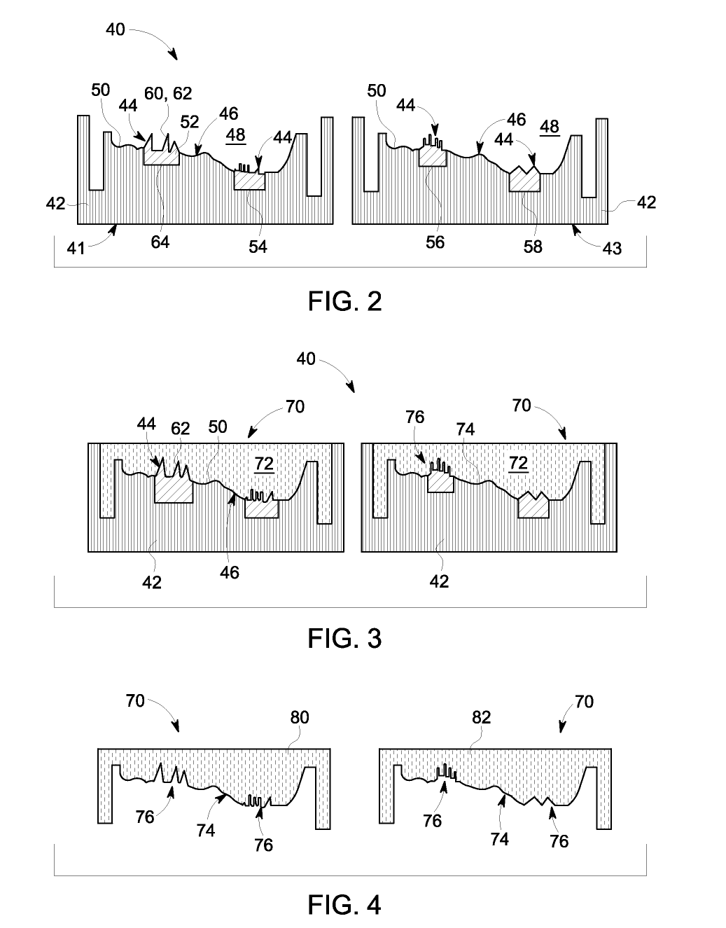

Referring now to FIG. 2, a mold assembly 40 is illustrated schematically. As illustrated, the mold assembly 40 may comprise one or more structural subassemblies, such as a first mold assembly structure 41 and a second mold assembly structure 43, which may be configured to produce associated cast components that may be assembled to form an overall cast component, which will be described in greater detail below. In the exemplary embodiment, the mold assembly 40 includes a primary mold structure 42 and at least one additional mold structure 44, but typically a plurality of additional interchangeable mold structures are included. The primary mold structure 42 has a predetermined geometry portion 46 defining a general structural geometry that is common to one or more cast components that will be described in detail herein. The predetermined geometry portion 46 is defined by a cavity region 48 including a surface 50. A number of materials may be employed to form the primary mold structure 42, but typically the primary mold structure 42 comprises a low-cost and relatively easy to machine material, such as a soft metal. Aluminum or soft steel are two examples of contemplated materials, however, it is to be understood that numerous alternative materials may be employed to form the primary mold structure 42.

Each of the at least one additional mold structures 44 are illustrated as having distinct geometries and may be referred to as a first secondary mold structure 52, a second secondary mold structure 54, a third secondary mold structure 56 and a fourth secondary mold structure 58. By way of example, the first secondary mold structure 52 includes a geometry 60 comprising a detailed surface 62, relative to the predetermined geometry portion 46 formed by the surface 50 of the primary mold structure 42. It can be seen that the detailed surface 62 includes intricate features that are substantially more detailed than the predetermined geometry portion 46 formed by the surface 50. As the time and cost associated with forming more intricate features increases with the level of detail, it is advantageous to avoid requiring the formation of a new primary mold structure having the desired detail for every potential cast component. Accordingly, the at least one additional mold structure 44 provides the ability to more cheaply and easily provide detail to cast components formed by the mold assembly 40 by simply forming the additional mold structures. In addition to more cheaply and easily forming the additional mold structures, an interchangeable aspect of the at least one additional mold structure 44 is obtained.

The at least one additional mold structure 44 may be removably fixed to the primary mold structure 42 to form the mold assembly 40 in a number of ways, including brazing, for example. The at least one additional mold structure 44 is integrated with the surface 50 of the primary mold structure 42 in a desired location corresponding to a design of a component cast by the mold assembly 40. A variety of integration methods may be employed to integrate the at least one additional mold structure 44 with the primary mold structure 42. Illustrative methods include brazing, welding, joining, fastening, or any combination thereof, but other methods are contemplated. In the exemplary embodiment, the at least one additional mold structure 44 is partially disposed within a channel 64 formed in the primary mold structure 42. Although the channel 64 is illustrated as having a substantially U-shaped geometry, it is to be appreciated that the channel 64 may take the form of any number of suitable geometries configured to at least partially locate and/or retain the at least one additional mold structure 44. As noted above, the at least one additional mold structure 44 is removable from the channel 64. Heating a brazed region between the plurality of secondary mold structures 44 and the primary mold structure 42, and more specifically the channel 64, facilitates removal of the at least one additional mold structure 44 from the channel 64.

Referring now to FIG. 3, a cast component 70 is formed by the mold assembly 40 by injecting a casting material 72 into the mold assembly 40 and into contact with the surface 50 of the primary mold structure 42 and the detailed surface 62 of the at least one additional mold structure 44. As the casting material 72 solidifies, a primary region 74 of the cast component 70 is formed by the predetermined geometry portion 46, while at least one feature 76 of the cast component 70 is formed by the geometry 60 of the detailed surface 62 of the at least one additional mold structure 44.

The cast component 70 may comprise a component employed in conjunction with any number of industries and applications, including a turbine component of the turbine system described above, such as the gas turbine engine 10 or a steam turbine, for example. In the turbine component application, exemplary embodiments of the cast component 70 may be a shroud or an airfoil, however, several other turbine components are contemplated.

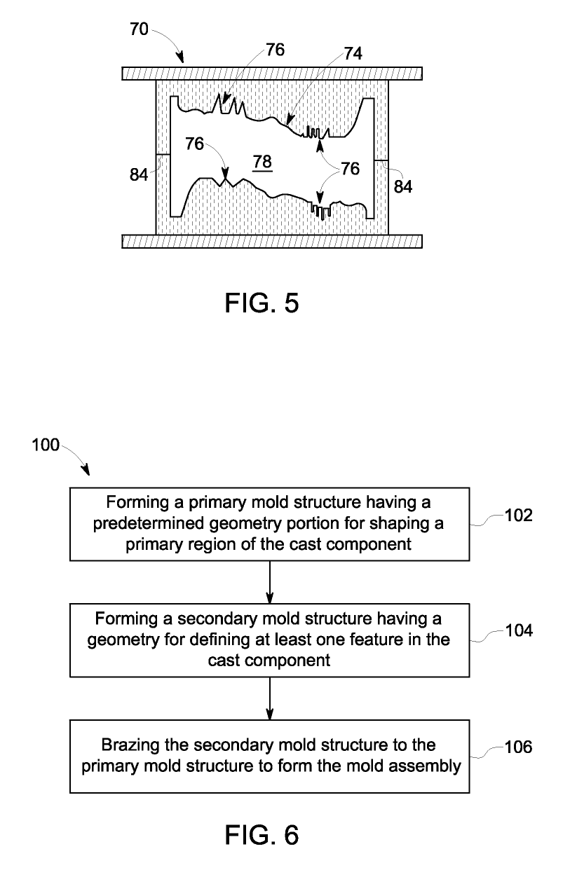

Referring to FIGS. 4 and 5, the cast component 70 may comprise a structure having a hollow region 78 defined by a first structure 80 and a second structure 82. The first structure 80 and the second structure 82 are joined proximate at least one joining interface 84. The cast component 70 may be assembled with the first structure 80 and the second structure 82 in any number of assembly methods, such as mechanical fastening or welding, for example.

As illustrated in the flow diagram of FIG. 6, and with reference to FIGS. 1-5, a method of manufacturing a mold assembly 100 is also provided. The mold assembly 40 and associated components have been previously described and specific structural components need not be described in further detail. The method of manufacturing a mold assembly 100 includes forming a primary mold structure having a predetermined geometry portion for shaping a primary region of the cast component 102. At least one additional mold structure is formed having a geometry for defining at least one feature in the cast component 104. The at least one additional mold structure is integrated with the primary mold structure to form the mold assembly 106.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A mold assembly for forming a cast component comprising:
a primary mold structure having a predetermined geometry portion for shaping a primary region of the cast component; and
at least one additional mold structure integrated with the primary mold structure, the at least one additional mold structure comprising a geometry for defining at least one feature in the cast component.

2. The mold assembly of claim 1, wherein the at least one additional mold structure and the primary mold structure are brazed, welded, joined, fastened, or any combination thereof, to each other.

3. The mold assembly of claim 1, further comprising a channel disposed in the primary mold structure.

4. The mold assembly of claim 3, wherein the at least one additional mold structure is brazed to, and at least partially disposed within, the channel of the primary mold structure.

5. The mold assembly of claim 1, wherein the at least one additional mold structure comprises a removable insert.

6. The mold assembly of claim 1, wherein the cast component comprises a turbine component of a turbine engine system.

7. The mold assembly of claim 1, wherein the cast component comprises a shroud.

8. The mold assembly of claim 1, wherein the cast component comprises an airfoil.

9. The mold assembly of claim 1, wherein the cast component comprises a hollow structure including a first segment and a second segment having at least one joining interface for joining the first segment and the second segment together.

10. The mold assembly of claim 1, wherein the cast component comprises a ceramic material.

11. A method of manufacturing a mold assembly comprising:
forming a primary mold structure having a predetermined geometry portion for shaping a primary region of a cast component;
forming at least one additional mold structure having a geometry for defining at least one feature in the cast component; and
integrating the at least one additional mold structure with the primary mold structure to form the mold assembly.

12. The method of claim 11, further comprising injecting a casting material proximate the primary mold structure and the at least one additional mold structure for forming of the cast component thereon.

13. The method of claim 11, further comprising forming a hollow cast component.

14. The method of claim 13, further comprising forming a first segment and a second segment with the mold assembly and forming at least one joining interface.

15. The method of claim 14, further comprising joining the first segment and the second segment to form the hollow cast component.

16. The method of claim 11, further comprising interchangeably integrating the at least one additional mold structure to the primary mold structure by brazing, welding, joining, fastening, or any combination thereof.

17. The method of claim 11, further comprising forming a channel in the primary mold structure and inserting at least a portion of the at least one additional mold structure within the channel.

18. The method of claim 11, further comprising forming the cast component with the mold assembly, wherein the cast component comprises a shroud.

19. The method of claim 11, further comprising forming the cast component with the mold assembly, wherein the cast component comprises an airfoil.

20. The method of claim 11, further comprising injecting a ceramic material proximate the primary mold structure and the at least one additional mold structure for forming of the cast component thereon.
